(19) United States
(12) Patent Application Publication
(10) Pub. No.: US 2007/0033137 A1
(43) Pub. Date: Feb. 8, 2007

(54) Converting patient payments into standardized electronic payment documents

(75) Inventors: Wayne A. Provost, Salt Lake City, UT (US); Ryan M. Trimble, Laguna Hills, CA (US); Kevin Phillips, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: P5, Inc.

(21) Appl. No.: 11/185,003

(22) Filed: Jul. 19, 2005

(51) Int. Cl. G06Q 40/00

(52) U.S. Cl. 705/40

(57) ABSTRACT

An electronic practice management system for use in healthcare environments includes one or more components for converting tangible payments into standardized electronic payment documents, such as a HIPAA 835 document. For example, a healthcare provider receives a tangible check, and passes the check through a check scanner, which electronically reads the check into one or more data fields. The read data fields can then be correlated with standardized fields in the HIPAA 835 document, and can be further correlated to a patient's account stored locally. The created 835 payment document can then be used to update the patient's account directly in the practice management system. Additional implementations include converting other tangible patient payments, such as credit card and cash payments, to create an 835 for similar ends.

### CROSS-REFERENCE TO RELATED APPLICATIONS

N/A

### BACKGROUND OF THE INVENTION

1. The Field of the Invention

This invention relates to systems, methods, and computer program products for maintaining payment records in a healthcare payment system.

2. Background and Relevant Art

Healthcare costs and related payment plans are increasingly complicated, whether from the perspective of the patient, the healthcare provider, or from the payer (i.e., patient, insurer, or other third party). In particular, from the time the patient enters a facility and receives care from the healthcare provider, a large number of forms may be filled out and passed around. These forms may document what care was received, who the patient saw, where the patient was seen, the services performed, and any full or partial payments made or anticipated to be made by the patient or relevant payer. Other forms may be used to document prior pricing recommendations from the payer, disputes regarding amount of requested payments, as well as payment timelines.

One can appreciate, therefore, that it can be a fairly complicated matter for the healthcare provider to balance all relevant payments from all relevant parties with respect to a patient account. For example, when a patient arrives at a healthcare facility, the patient will often provide some form of third-party payer information (e.g., insurance carrier), which will ultimately be used to satisfy a balance on the patient's account. In those cases, the healthcare provider will typically document what the patient already paid, if anything, post that to the patient's account, and then send a corresponding claim to the identified payer for any reminder. The healthcare provider will then need to close out the day of business by balancing, for each patient account, any payments received by the patient (or by the third-party payer), as well as claims submitted for remaining balances.

Recently, healthcare providers that use electronic practice management systems (“PMS”), and that want to satisfy patient balances through electronic funds transfers from third-party payers, need to be able to send and receive messages formatted according to the American National Standards Institute (ANSI) Accredited Standards Committee (ASC) X12 835 format. In particular, the federal Health Insurance Portability and Accountability Act of 1996 (HIPAA) requires third-party electronic payment and documentation to be formatted as “835” electronic messages, which are commonly called an “835”, a “HIPAA-compliant 835”, or a “HIPAA 835.” That is, healthcare providers submit claims in an electronic format message called the “837” (similar in some respects to the 835 format), and the insurance providers can pay those claims using the electronic 835 format message. The 835 can also be tagged with different fields to denote appeals, recommendations, or other information as appropriate.

Unfortunately, the 835 is configured primarily for handling third-party payer information of a patient account, and is not specifically tailored for handling the patient payment component of the patient account. For example, the healthcare provider might need to manually create a new electronic document for each patient payment received, so that the healthcare provider can balance the patient payments with any received third-party payments (or submitted claims) in the same system, received as 835 s. This, however, can be cumbersome for the healthcare provider, particularly when handling checks, cash or credit card payments. For example, prior to submitting to a bank tangible payments such as check and cash payments, the healthcare provider might enter payment information into a spreadsheet with various fields for the price of service, date or service, type of service, patient name, and so on. In some cases, the healthcare provider might also scan the checks in order to retain an, image of the check for local record keeping purposes.

The spreadsheet can then be converted to an appropriately formatted electronic document, such as an 835 or equivalent, and then be posted to the patient's account on the healthcare provider's practice management system. Alternatively, the healthcare provider might simply avoid the hassle, and manage patient payment through a separate system that does not necessarily use a specifically formatted electronic payment document. This, of course, can lead to other inefficiencies, such as making it difficult to reconcile different payments for a single patient account, particularly since electronic payments from insurers are required to be in the standardized 835 format. In any event, there is not presently a system that automatically receives and balances standardized electronic payment documents from multiple types of payers.

Accordingly, an advantage in the art can be realized with systems, methods, and computer program products that simplify the patient payment component of a healthcare provider remittance system, such that all forms of payment to a patient account from any type of payer can be more easily reconciled through a practice management system.

### BRIEF SUMMARY OF THE INVENTION

The present invention solves one or more of the problems in the art with systems, methods, and computer program products configured to ensure patient payments can be easily balanced in a practice management system. In particular, implementations of the invention relate to automatically generating an 835 payment document from tangible patient payments, such as from a patient-provided check. The 835 generated for the patient payment can then be posted immediately to the patient's account in the practice management system, and can be readily balanced with other 835 s received from other payers.

For example, one method in accordance with an implementation of the present invention involves receiving a tangible form of payment for healthcare services given to a patient, such as a check, or a receipt from another form of payment, and electronically reading data associated with the tangible form of payment. The data that are electronically read can then be recognized and placed into one or more electronic data fields. The method also involves correlating the one or more read electronic data fields with one or more standardized fields associated with a standardized electronic payment, such as a HIPAA 835 payment document. Upon appropriate correlation, a standardized electronic payment document can then be created, which can be used to electronically balance a patient account in an electronic practice management system.

An exemplary system in accordance with the present invention includes one or more components, including a payment database that is configured to store one or more patient accounts, and one or more standardized electronic healthcare payment forms. The system also includes one or more read interfaces configured to generate electronic data in response to corresponding patient payment(s) for healthcare services. In addition, the system includes a conversion module for taking the generated electronic data from the one or more read interfaces and creating one or more standardized electronic healthcare payment documents that correspond to the one or more standardized electronic healthcare payment forms. In one implementation, the system components can be positioned/stored in one location, and can also be positioned/stored in separate locations communicating over a network with the foregoing, as well as potentially still other components.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a practice management system in accordance with an implementation of the present invention in which the practice management system is configured to receive data representing tangible forms of patient payments;

FIG. 1B illustrates a schematic diagram in accordance with an implementation of the present invention for automatically converting electronically read patient payment data into a standardized electronic payment document;

FIG. 2 illustrates a schematic diagram in accordance with an implementation of the present invention of a decision tree in which payment data is automatically converted to standardized electronic payment document format and posted in a practice management system;

FIG. 3 illustrates a sequence of acts in a flowchart of a method in accordance with an implementation of the present invention for automatically converting a patient payment into a standardized electronic payment document; and

FIG. 4 illustrates a sequence of acts in a flowchart of a method in accordance with an implementation of the present invention for automatically updating an electronic patient account in a practice management system with data read from a tangible check.

### DETAILED DESCRIPTION OF THE PREFERRED EMBODIMENTS

The present invention extends to systems, methods, and computer program products configured to ensure patient payments can be easily balanced in a practice management system. In particular, implementations of the invention relate to automatically generating an 835 payment document from tangible patient payments, such as from a patient-provided check. The 835 generated for the patient payment can then be posted immediately to the patient's account in the practice management system, and can be readily balanced with other 835 s received from other payers.

Accordingly, implementations of the present invention allow a healthcare provider to view payments from multiple payers in a consistent format. For example, as will be understood more fully from the following description and claims, a healthcare provider receives a tangible form of payment, such as a physical check, cash, or a credit card receipt. In the case of the check, the healthcare provider passes the check through an automatic check reader, which provides an image, as well as payment data to a data store in a practice management system. The healthcare provider can also enter cash or credit card expenses into a user interface at a computerized system, which is then also passed to the data store. One or more components in the computerized system then automatically convert the data, however entered, into a standardized electronic payment document for use in balancing the patient's account.

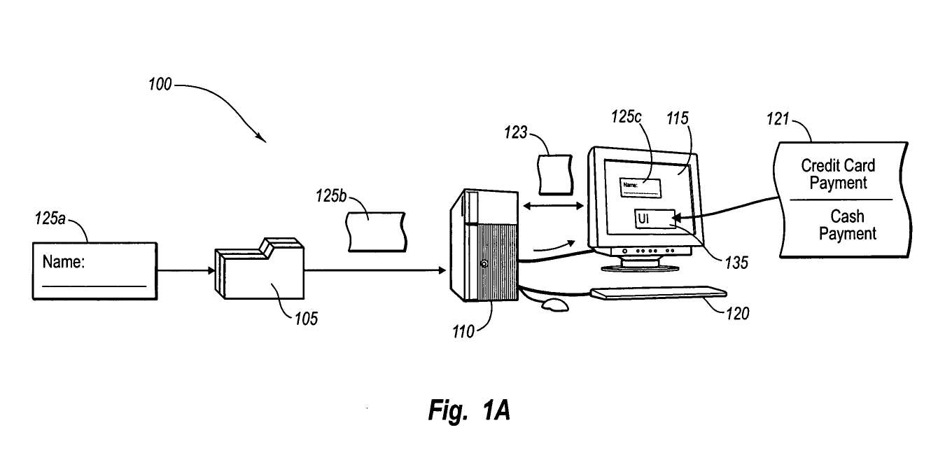

For example, FIG. 1A illustrates a practice management system 100 in accordance with an implementation of the present invention in which a computer system 110 is configured to receive data for one or more sources of payment (e.g., 121, 125a). As shown, the computer system 110 is coupled to any number of peripherals (whether directly, or through a network connection), such as display interface 115, a keyboard 120, and a scanning device 105. The system 100 is generally set up so that a healthcare provider enters received credit card payment or cash payment information 125b manually via keyboard 120 through a user interface 135. Of course, the healthcare provider may also enter the raw cash or credit card data to the computer system, such as via coupling to a cash register, or to a credit card machine, which is then viewable through the user interface 135.

FIG. 1A also shows that the healthcare provider can receive tangible check payments 125a through a scanning device 105, such as a conventional check reader. Rather than pass the data read in the check scanner 105 only to a bank, however, FIG. 1A shows that the data 125b read from the check 125a can also be passed to the computer system 110, and displayed. The check data can then be passed onto the appropriate bank after the check data have also been read locally. For example, FIG. 1A shows that upon scanning the tangible check 125a, payment information 125b corresponding to the tangible check 125a is passed from the scanning device 105 to the computer system 110. The payment information 125b contained in the check 125a can then be viewed as image 125c through the display device 115. Image 125c can then help the healthcare provider ensure that the check 125a was read properly.

For example, the patient's name, checking account number, and bank routing number can be automatically read when scanned with some ease since this information is typically professionally printed in standard font characters. The amounts of the patient payment, however, may be less easy to read for the scanning device, depending on the legibility of the patient's handwriting that can be recognized through optical character recognition (“OCR”). Thus, in one implementation, the healthcare provider also uses the displayed form 125c and one or more user interfaces to ensure that the scanner 105 has read the appropriate amount. For example, the healthcare provider can use user interface 135 (or another interface—not shown) to correct remaining fields in the check that may have been optically read incorrectly. In any event, the payment information, whether received from a scan or from manually entering, is put into a raw electronic document 123 having one or more fields 155.

The raw electronic document 123 is then converted automatically into an 835 electronic payment document. For example, FIG. 1B shows that the raw payment information 123 includes any number of raw information fields 155, including name and address information, as well as checking account number, bank routing number, payment data, amount and so forth. Conversion module 145 then pulls a standard template 160 from a template component 153 of data store 140 and identifies one or more fields in the standard template 160. Conversion module 145 also correlates one or more fields 155 of the newly created payment document 123 with fields 165 in the template 160, to automatically create standardized electronic payment document 163, such as an 835.

Conversion module 145 can also find the appropriate patient account (i.e., 170) for posting the 835, by matching one or more fields 155 (or in the 835) with a corresponding field in patient account 170. For example, conversion module 145 identifies a name field in document 123, a bank account number in the document 123, or name or patient account information in the created document 163. The conversion module 145 then matches the identified field with prior payment information used for the given patient.

In general, patient account 170 is found in data store 140, and comprises for example a partition 170a for storing claims (i.e., payment owed for services), which can include any HIPAA 837 documents. The patient account 170 can also include a partition 170b for storing present, pending, or prior payment documents, such as the electronic payment document 163 created from payment information 123.

As such, when the conversion module 145 creates the electronic payment document 163 based on cash or credit/debit card receipts, conversion module places the document 163 into the corresponding “paid” partition 170b of the appropriately identified patient account 170. By contrast, the conversion module 145 can also transmit any read check information to the appropriate bank (e.g., based on the bank routing number), before or after posting the created 835 payment document 163 to patient account 170. If posted to patient account 170 before the bank replies with check clearance information, conversion module 145 might designate the created 835 document 163 only as “pending”. When the bank finally sends the clearance information, and it is received, conversion module 145 may then update the created, posted 835 document 163 to a status of “paid”.

Accordingly, FIGS. 1A and 1B show how patient payment data can be automatically converted into a standardized electronic payment document for use in a practice management system.

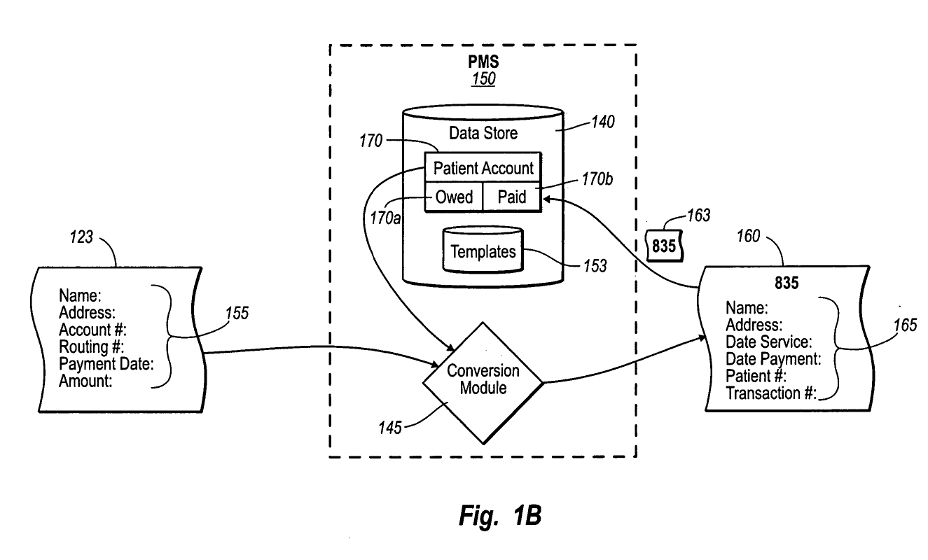

FIG. 2 illustrates a generalized decision tree schematic in accordance with an implementation of the present invention for converting payment data into a standardized electronic payment document format, such as an 835. For example, FIG. 2 shows that a decision tree in accordance with the present invention comprises a step 200 of receiving payment data. For example, the healthcare provider receives check 125a, cash, and/or credit card payments 121, and converts the payments into electronic data, such as by scanning the check, or by entering various amounts, transaction dates, and so on as necessary. The decision tree also comprises a step 205 of collecting data. For example, conversion module 145 examines the electronic data and delineates the information in appropriate fields 155 that correlated to fields 165 of the standardized electronic payment document (e.g., a HIPAA 835) 160.

In addition, FIG. 2 shows that, upon collecting the data, a decision 210 is made regarding the validity of the read data. For example, if there is no patient name, payment amount, or patient account information found in the read data (e.g., a scan of payment amount in the check was illegible), the conversion module 145 might be unable to correlate the read data appropriately to generate the 835, or to pass any generated 835 to a corresponding patient account. In such a case, the decision tree of FIG. 2 shows that the error is handled in step 215, which includes generating an error report. For example, the conversion module 145 sends information to display device 115, which displays the name or type of missing fields.

In any event, if the data are valid, FIG. 2 shows that the decision tree includes a step 220 of converting the data to a standardized 835 document. For example, the conversion module 145 correlates the fields 155 read at one or more peripheral devices (e.g., 105) with fields 165 of the standardized electronic payment document 160, and creates a corresponding 835 (e.g., 163). In addition, the decision tree includes a step 225 of delivering the standardized electronic payment document to the client. For example, if the data collection and processing are handled off site by a third-party practice management system, the third-party practice management system will then send the created 835 back to the client's local practice management system via network communication.

Accordingly, FIG. 2 further shows that the decision tree includes a step 230 of receiving the 835, as well as a step 235 of processing and posting the 835. For example, upon receipt from the third-party practice management system, or upon creation (locally) of the 835, the 835 (i.e., standardized payment document) is then placed in a “paid” partition 170b of the corresponding patient account in data store 140. Thus, the decision tree in Figure provides a composite overview of data flow for the system 100.

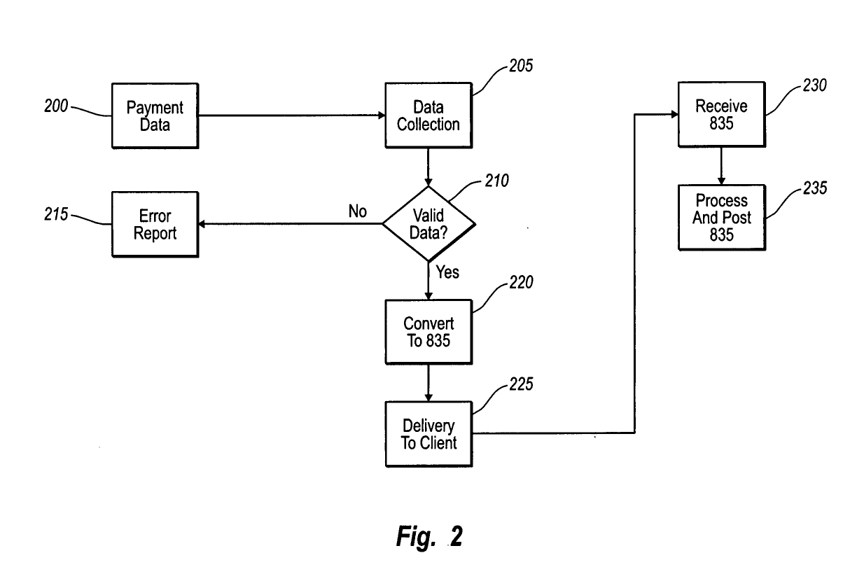

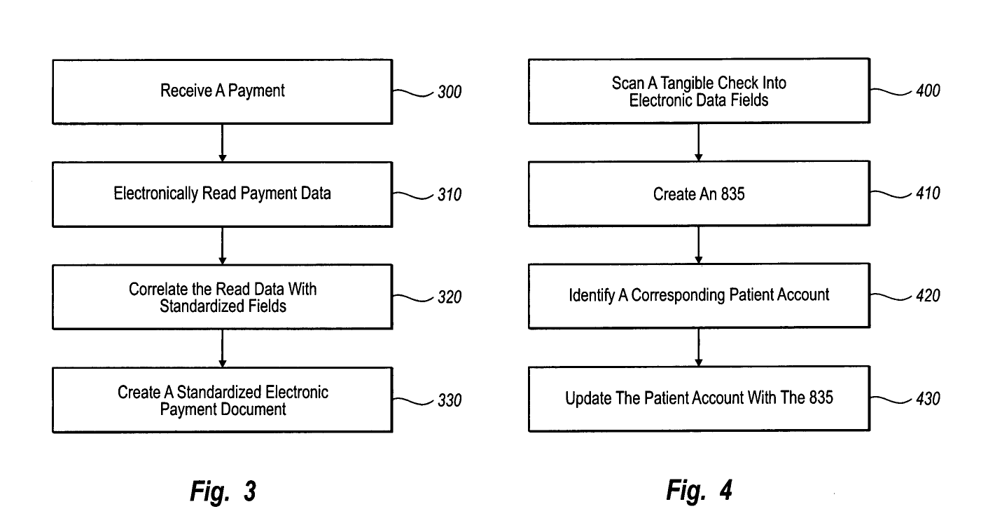

The present invention can also be described in terms of acts for performing methods in accordance with the present invention. For example, FIGS. 3 and 4 illustrate flow charts based on acts in alternative methods for handling patient payment information. The flow charts illustrated in FIGS. 3 and 4 are described below with respect to the schematic diagrams in FIGS. 1A through 2.

In particular, FIG. 3 shows that a method of converting non-electronic versions of a payment into a standardized electronic payment document comprises an act 300 of receiving a payment. Act 300 includes receiving a tangible form of payment for healthcare services given to a patient. For example, the healthcare provider receives payments 121 and/or 125a, which include tangible checks, cash currency, and/or credit or debit receipts.

FIG. 3 also shows that the method comprises an act 310 of electronically reading payment data. Act 300 includes electronically reading data associated with the tangible form of payment, such that the data are read into one or more electronic data fields. For example, as shown in FIGS. 1A and 1B, scanning device 105 electronically reads check 125a and deduces fields 155 in an electronic document 123 of the data. Alternatively, the document 123 data are entered or received into a user interface 135 viewed through a display device 115.

In addition, the method comprises an act 320 of correlating the read data with standardized fields. Act 320 includes correlating the one or more read electronic data fields with one or more standardized fields associated with a standardized electronic payment. For example, conversion module 145 compares fields 155 of the electronic document 123 with fields 165 of a standardized electronic payment document 160 pulled from a partition 153 of standardized templates.

Furthermore, the method of FIG. 3 comprises an act 330 of creating a standardized electronic payment document. Act 330 includes creating a standardized electronic payment document based on the tangible form of payment, such that the tangible form of payment can be used to electronically balance a patient account in an electronic practice management system. For example, the conversion module 145 fills fields 165 of an electronic template and saves the template as a standardized electronic payment document 163, such as the HIPAA 835 payment document. Accordingly, FIG. 3 illustrates at least one method in accordance with an implementation of the present invention in which one can create, for example, an 835 document.

FIG. 4 illustrates an alternative implementation of the present invention for updating a patient account in a practice management system using a tangible check. In particular, FIG. 4 shows that the method comprises an act 400 of scanning a tangible check into electronic data fields. Act 400 includes scanning one or more data fields of a tangible check into one or more electronic data fields. For example, scanner 105 performs one or more electronic character recognition functions on tangible check 125a, such as reading imprinted checking account and routing number information, as well as optical recognizing certain handwriting pertaining to amounts, dates, signatures, and so forth.

The method of FIG. 4 also comprises an act 410 of creating an 835. Act 410 includes creating an 835 based on at least an electronic name field and an electronic payment amount field in the one or more read electronic data fields. For example, conversion module 145 compares fields 155 read from electronic document 123 with fields 165 from a document template 160, and creates a corresponding 835 document for the payment.

In addition, the method comprises an act 420 of identifying a corresponding patient account. Act 420 includes identifying a patient account that correlates at least with the electronic name field. For example, the conversion module 145, or some other component in the practice management system 150, scans one or more data fields for each patient account (e.g. 170), and identifies a match with corresponding data fields 165 (e.g. name field, bank account number) of the created 835 document.

Furthermore, the method of FIG. 4 comprises an act 430 of updating the patient account with the 835. Act 430 includes updating an entry for the identified patient account in a payment database based on the created 835. For example, the conversion module 145, or some other component in the practice management system 150 passes the newly created 835 (i.e., document 163) into a “paid” partition, (or “pending, paid” partition, e.g., the check has not cleared) of patient account 170. Other payments in this partition include payments or pending payments from other payers, such as insurers and the like. As such, the healthcare provider has relatively quick access to account balances based on claims and electronic formats of payments made during the day, and does not have to view payments and claims in separate systems.

The schematic diagrams and methods described above, therefore, provide a number of mechanisms, systems, and methods, for standardizing tangible and electronic forms of payment. In particular, implementations of the present invention allow a healthcare provider to seamlessly intermingle payments from multiple payers, including patient payers, third-party payers, and any combination thereof, using multiple types of payments using standardized electronic payment documents. Thus, patient account balances can be managed effectively and efficiently for the healthcare provider.

One will appreciate that embodiments of the invention include or are incorporated in computer-readable media having computer-executable instructions or related data structures stored thereon. Examples of computer-readable media or computer program products include the volatile or non-volatile storage media, including but not limited to RAM, ROM, EEPROM, Flash media, CD-ROM, DVD, or other optical or magnetic storage, as well as any corresponding optical or magnetic storage devices, and/or any other media capable of storing electronic computer-executable instructions or related electronic data structures that are capable of being accessed and/or processed by a general purpose or special purpose computerized system. Computer-readable media also encompasses any appropriate combinations of the foregoing.

Computer-executable instructions comprise, for example, general text instructions in the case of scripts, or compiled instructions in the case of compiled program code, and/or relevant data that are read by one or more components of a general purpose or special purpose computerized system. When read, interpreted, and/or executed, these instructions cause one or more processors of the general purpose or special purpose computerized system (or special purpose processing device) to execute a function or group of functions. As such, computer-executable instructions and associated data structures represent an example of program code means for executing the acts or steps of the invention disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a computerized environment in which a healthcare provider receives payments from one or more patients and/or one or more payers, a method of converting tangible forms of a patient payment into a standardized electronic payment document for use in an electronic practice management system, comprising:
electronically reading data associated with the tangible form of payment that has been received for healthcare services given to a patient, such that the data are read into one or more electronic data fields;
correlating the one or more read electronic data fields with one or more standardized fields associated with a standardized electronic payment; and
creating a standardized electronic payment document based on the tangible form of payment, such that the tangible form of payment can be used to electronically balance a patient account in an electronic practice management system.

2. The method as recited in claim 1, wherein the standardized fields represent one or more fields of a standardized HIPAA 835 document, such that the created standardized electronic payment document is an 835 payment document that represents the tangible form of payment.

3. The method as recited in claim 1, wherein the tangible form of payment is any of cash, a check, a credit card receipt, or a debit card receipt.

4. The method as recited in claim 1, further comprising receiving information that has been manually entered into a user interface, including any one or more of:
a name for the patient;
an address for the patient;
a date of service;
a date of payment; and
an amount of payment.

5. The method as recited in claim 1, wherein the tangible form of payment is a check, the method further comprising passing the check through a check scanner.

6. The method as recited in claim 5, further comprising optically recognizing handwriting on the check, such that any of an amount, transaction date, or signature can be determined through the check scanner.

7. The method as recited in claim 5, wherein the data read include any of an account number, a routing number, a date of payment, a name, an address, and an amount of payment.

8. In a computerized environment in which a healthcare provider receives payments from one or more patients and/or one or more payers, a method of automatically updating a standardized electronic practice management system, using a tangible check comprising:
scanning one or more data fields of a tangible check into one or more electronic data fields;
creating an electronic HIPAA 835 document based on at least an electronic name field and an electronic payment amount field in the one or more electronic data fields;
identifying a patient account that correlates at least with the electronic name field; and
updating a payment entry for the identified patient account in a payment database, wherein the update is made in accordance with the created electronic HIPAA 835 document.

9. The method as recited in claim 8, further comprising optically recognizing any of the one or more data fields of the tangible check that are handwritten.

10. The method as recited in claim 9, further comprising providing a user interface into which any corrections can be made to the any optical recognized one or more data fields.

11. The method as recited in claim 8, further comprising identifying at least one of the one or more electronic data fields as the electronic name field, such that identifying a patient account further includes matching the identified electronic name field with a name field for the patient account.

12. The method as recited in claim 8, wherein a third-party vendor creates the electronic HIPAA 835 document, and wherein the payment database is stored at a location of the healthcare provider.

13. The method as recited in claim 12, further comprising the third-party vendor transmitting the created electronic HIPAA 835 document to the payment database at the healthcare provider location over a network.

14. The method as recited in claim 8, further comprising transmitting the one or more scanned data fields to a bank.

15. The method as recited in claim 14, further comprising:
receiving an indication from the bank that the tangible check has a status of one of cleared, in process, or denied; and
updating the created electronic HIPAA 835 document to reflect the indication received from the bank.

16. In a computerized system in a healthcare environment in which a healthcare provider receives tangible payments from one or more patients and/or one or more payers, a system for automatically converting tangible payments into standardized electronic payment documents for use in an electronic practice management system, comprising:
a payment database storing one or more patient accounts, and one or more standardized electronic healthcare payment forms;
one or more read interfaces configured to generate electronic data in response to corresponding physical input related to a patient payment for healthcare services; and
a conversion module configured to take the generated electronic data from the one or more read interfaces and create one or more standardized electronic healthcare payment documents corresponding to the one or more standardized electronic healthcare payment forms.

17. The system as recited in claim 16, wherein the payment database, the one or more read interfaces, and the conversion module are stored at a single physical location for the healthcare provider.

18. The system as recited in claim 16, wherein the one or more patient accounts are configured to receive any HIPAA 835 payment document automatically generated from the patient payment or from a third-party payer.

19. The system as recited in claim 16, further comprising a network connection to any of a bank or a third-party vendor, such the bank can provide clearance information for the patient payment to the healthcare provider, and such that the third-party vendor can transmit a HIPAA 835 payment document to the healthcare provider over the network.

20. In a computerized environment in which a healthcare provider receives payments from one or more patients and/or one or more payers, a computer program product having computer-executable instructions stored thereon that, when executed, cause one or more processors in a computerized system to perform a method of converting tangible, non-electronic forms of a patient payment into a standardized electronic payment document, comprising the following:
scanning one or more data fields of a tangible check into one or more electronic data fields;
creating an electronic HIPAA 835 document based on at least an electronic name field and an electronic payment amount field in the one or more electronic data fields;
identifying a patient account that correlates at least with the electronic name field; and
updating a payment entry for the identified patient account in a payment database, wherein the update is made in accordance with the electronic HIPAA 835 document.
